(19) United States
(12) Patent Application Publication
(10) Pub. No.: US 2006/0240713 A1
(43) Pub. Date: Oct. 26, 2006

(54) Card connector

(75) Inventors: Hitoshi Kikuchi, Tokyo (JP); Hirokazu Takahashi, Tokyo (JP); Kazunori Takei, Tokyo (JP); Hiromichi Kato, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: DDK LTD., Tokyo (JP)

(21) Appl. No.: 11/372,608

(22) Filed: Mar. 9, 2006

(30) Foreign Application Priority Data
Apr. 21, 2005 (JP) 2005-123252

(51) Int. Cl. H01R 24/00

(52) U.S. Cl. 439/630

(57) ABSTRACT

A card connector which is able to be connected to at least two cards, includes contacts corresponding to the number of the cards, a tray in which at least two cards can be mounted, and a housing having a fitting opening for receiving the tray therein and for arranging and holding the contacts. Also, a card connector which is able to be connected to four cards, includes four kinds of contacts, a tray having card mounting sections in which four cards can be mounted, and a housing having a fitting opening for receiving the tray therein and for arranging and holding the four kinds of contacts. With these constructions, miniaturization in height or reduced overall height of connector is possible with a simple construction.

### BACKGROUND OF THE INVENTION

This invention relates to a card connector for use in electric and electronic appliances in instruments and for use in printers and card readers and more particularly to a card connector miniaturized in height by the use of a tray.

There have been many kinds of cards as media for a wide variety of information. It has been a common practice to acquire or store various information from or onto a card inserted into a card connector connected to an information appliance.

In order to connect cards to a card connector, the connector may be provided with a plurality of fitting openings for receiving a required number of cards therein, and contact portions of contacts may extend into the fitting openings so as to bring the cards into contact with the contact portions of the contacts, thereby achieving continuity therebetween.

With these card connectors, it may be considered that there are provided fitting openings of the number corresponding to the number of required cards or there is provided a single fitting opening which is able to receive a plurality of cards. As shown in Patent Literatures 1 to 4 described below, card connectors having fitting openings for cards arranged one above the other are disclosed in the Patent Literatures 1 and 4 and FIG. 8 of the Patent Literature 2, and a connector having fitting openings each capable of receiving a plurality of cards is disclosed in the Patent Literature 3.

Patent Literature 1

According to the Abstract of Japanese Patent Application Opened No. 2001-357,917, this invention has an object to provide a method for arranging contacts of a connector for memory cards, which is able to receive cards in a plurality of inserting openings arranged one above the other and to bring the contacts for the plurality of inserting openings into contact with substrates with ease, in spite of narrow occupied areas of the substrates. Disclosed in the Patent Literature 1 is the method for arranging contacts of a memory card connector comprising a housing having fitting openings for receiving two cards, and the contacts held and fixed by the housing, wherein the contacts adapted to contact a card inserted into the upper inserting opening are arranged to extend in both width directions of the housing and to be connected to patterns of the substrate. As shown in FIG. 1 of the Patent Literature 1, the fitting openings for receiving cards are arranged one above the other.

Patent Literature 2

According to the Abstract of Japanese Patent Application Opened No. 2001-351,709, this invention has an object to provide a connector into which a plurality of memory cards different in thickness are selectively inserted for operating information appliances. A connector main body comprises side walls on both sides and a rear wall, the side walls being formed with receiving portions along their length adapted to conform to side edges of cards. The connector comprises card identification terminals arranged one above the other on the inner surface of the side wall, terminals suitably provided on the rear wall for acquiring the accumulated information in the cards and writing electronic information to cards, and protective terminals arranged at suitable positions on the other side wall for prohibiting writing. The card identification terminals are formed by spring-like metal strips and arranged one above the other on one side wall of the connector, while identification tabs for identifying the existence of cards by contacting the respective card identification terminal are arranged on the side wall and spaced from the card identification terminals when no card is inserted. As shown in FIGS. 7 and 8, fitting openings for receiving cards are suitably arranged one above the other.

Patent Literature 3

According to the Abstract of Japanese Patent Application No. 2004-307,794, the invention has an object to provide a card connector which, once a card has been inserted, is capable of preventing a further card from being inserted with a simple construction and capable of achieving the miniaturization of the connector without any limitation in substrate circuit design without obstructing high-density of contacts, and is easy to design the housing and easy to insert and remove a card. A card connector into and from which a plurality of memory cards are inserted and removed, including a plurality of contacts adapted to contact the connection portions of the plurality of memory cards, and a housing having a plurality of inserting openings for receiving the plurality of memory cards and for arranging and holding the contacts, wherein the housing includes at predetermined positions a required number of sliders forming parts of the plurality of inserting openings and a required number of holders for movably holding the sliders so that one kind of memory cards can only be inserted. As shown in FIG. 1, the fitting openings are suitably arranged, which can receive five cards.

Patent Literature 4

According to the Abstract of Japanese Patent Application No. 2004-321,645, this invention has an object to provide a card connector which is easy to assemble and superior in mounting operationality by a customer without limiting the freedom of design of substrates and connector, and without complicating arrangement of connection portions of contacts. Disclosed in this application is a card connector into and from which a plurality of cards are inserted and removed, including a required number of contacts each having a contact portion adapted to contact a card, and a housing arranging and holding the contacts and having one or a plurality of fitting openings into which a card or cards are inserted, wherein the contacts each comprise at least two contact portions adapted to contact at least two cards, thereby enabling one contact to be in contact with at least two cards. As shown in FIG. 1 of the Patent Literature 4, the fitting openings are arranged one above the other, although they have some portions common to different cards.

In recent years, miniaturizations have proceeded in the information appliances as well as substrates or cards used therein so that areas occupied by the substrates have become extremely narrower. Such a limitation of area occupied by the substrate necessarily leads to the use of a plurality of substrates. On the other hand, if a plurality of connectors are required for exchanging a plurality of memory cards, information appliances would become bulky which would be inconvenient for carrying them.

In the case that there is a limitation in height, particularly, the card connectors as disclosed in the Patent Literatures 1 to 4 cannot achieve miniaturization in height of connectors because their fitting openings for receiving cards are arranged one above the other.

With a card connector for receiving a plurality of cards different in thickness into a single fitting opening, the construction would become complicated because of difference in length and width of the cards.

Moreover, as there are cards having lengths shorter than those of other kinds of cards, insertion and removal of such short cards would become difficult in the usual slot system.

### SUMMARY OF THE INVENTION

It is an object of the invention to provide a card connector which overcomes the disadvantages of the prior art described above and which is simple in construction and achieves the miniaturization in height or reduced overall height of the connector.

The above object can be achieved by a card connector 10 which is able to be connected to at least two cards 60 and comprises contacts 14 corresponding to the number of the cards 60, a tray 16 in which at least two cards 60 can be mounted, and a housing 12 having a fitting opening 20 for receiving the tray 16 therein and for arranging and holding the contacts 14.

The above object can also be achieved by a card connector 10 which is able to be connected to four cards 60 and comprises four kinds of contacts 14, a tray 16 having card mounting sections 22 in which four cards 60 can be mounted, and a housing 12 having a fitting opening 20 for receiving the tray 16 therein and for arranging and holding the four kinds of contacts 14.

The tray 16 is provided with at least one card mounting section 22 having at least one part overlapping in relation to cards 60 other than one card intended to be mounted in the card mounting section so as to allow the intended one card 60 only to be mounted in the card mounting section. It is possible to mount only one card 60 in the card mounting section of the tray by means of other measures such as a sensor, metal spring switch or metal dome switch and the like for identifying cards. Among them, the metal spring switch is preferable in view of cost and ease in assembling.

The tray 16 is provided with at least one card mounting section 22 not having a part overlapping in relation to at least two cards 60 so as to allow at least the two cards 60 to be mounted in the card mounting section 22, and the tray 16 is further provided with card identification means for identifying the cards 60 to be used. In the case that a plurality of cards 60 are mounted, as means for identifying cards to be used there are a sensor, metal spring switch or metal dome switch and the like for identifying cards. Among them, the metal spring switch is preferable in view of cost and ease in assembling.

The housing 12 is provided with stopper means on the side of the fitting opening 20 for preventing the tray 16 from being extended from the housing.

The card connector further comprises means for drawing the tray 16 to some extent relative to the housing by pushing the tray 16 in the state that insertion of the tray 16 has been completed. As mechanisms for removing the tray 16 there are means using a coil spring 18 and a heart cam, means using an ejector lever and slider, and the like. In view of the cost, ease in assembling and miniaturization of connector, use of the coil spring 18 and heart cam is preferable.

As can be seen from the above description, the card connector 10 according to the invention can bring about the following significant functions and effects.

(1) According to the invention, the card connector 10 which is able to be connected to at least two cards 60, comprises contacts 14 corresponding to the number of the cards 60, a tray 16 in which at least two cards 60 can be mounted, and a housing 12 having a fitting opening 20 for receiving the tray 16 therein and for arranging and holding the contacts 14. Therefore, only by inserting the tray 16 together with a plurality of cards 60 mounted therein into one fitting opening 20, a connection between the cards 60 and the respective contacts 14 can be easily achieved and at the same time the miniaturization in height of connector can be achieved.

(2) According to the invention, the card connector 10 which is able to be connected to four cards 60, comprises four kinds of contacts 14, a tray 16 having card mounting sections 22 in which four cards 60 can be mounted, and a housing 12 having a fitting opening 20 for receiving the tray 16 therein and for arranging and holding the four kinds of contacts 14. Accordingly, only by inserting the tray 16 together with four cards 60 mounted therein into one fitting opening 20, a connection between the cards 60 and the respective contacts 14 can be easily achieved and at the same time the miniaturization in height of connector can be achieved.

(3) According to the invention, the tray 16 is provided with at least one card mounting section 22 having at least one part overlapping in relation to cards 60 other than one card intended to be mounted in the card mounting section so as to allow the intended one card 60 only to be mounted in the card mounting section. Therefore, as one card 60 can only be mounted in the card mounting section 22 of the tray 16, the integrated circuit for controlling the card 60 does not cause any error and stable connection to the card can be achieved with a simple structure.

(4) According to the invention, the tray 16 is provided with at least one card mounting section 22 not having a part overlapping in relation to at least two cards 60 so as to allow at least the two cards 60 to be mounted in the card mounting section 22, and the tray 16 is further provided with card identification means for identifying the cards 60 to be used. Consequently, even if a plurality of cards 60 are inserted into the card connector at a time, the integrated circuits for controlling the cards 60 do not cause any error, thereby achieving stable connection to the cards 60 with the aid of the simple construction for limiting the cards to be used.

(5) According to the invention, the housing 12 is provided with stopper means on the side of the fitting opening 20 for preventing the tray 16 from being extended from the housing. Therefore, the tray 16 is prevented from being dislodged from the housing 12, thereby protecting the tray 16 and cards 60 from being damaged.

(6) According to the invention, the card connector further comprises means for drawing the tray 16 to some extent relative to the housing by pushing the tray 16 in the state that insertion of the tray 16 has been completed. Accordingly, the tray 16 can be readily removed from the housing.

The invention will be more fully understood by referring to the following detailed specification and claims taken in connection with the appended drawings.

### BRIEF DESCRIPTION OF THE DRAWING

FIG. 1A is a perspective view of a connector according to the invention viewed from the fitting opening side;

FIG. 1B is a perspective view of the connector according to the invention viewed from the opposite side of the fitting opening;

FIG. 2A is a perspective view of the connector according to the invention with the tray removed, viewed from the fitting opening side;

FIG. 2B is a perspective view of the connector according to the invention with the tray removed, viewed from the opposite side of the fitting opening;

FIG. 3A is a perspective view of a tray used in the card connector according to the invention;

FIG. 3B is a perspective view of the tray with one card mounted therein;

FIG. 4A is a perspective view of a tray used in the card connector according to the invention;

FIG. 4B is a perspective view of the tray shown in FIG. 4A with a plurality of cards mounted therein;

FIG. 5 is a perspective view of the connector with the tray drawn out, viewed from the fitting opening side; and

FIGS. 6A to 6I are views for explaining positional relationship between a tip of coil spring and precut grooves when the tray is inserted into and removed from the housing.

### DESCRIPTION OF THE PREFERRED EMBODIMENTS

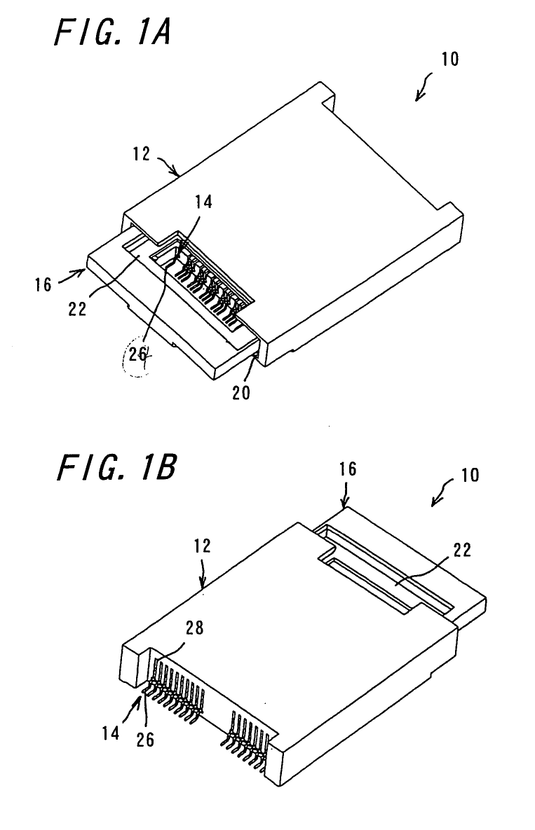

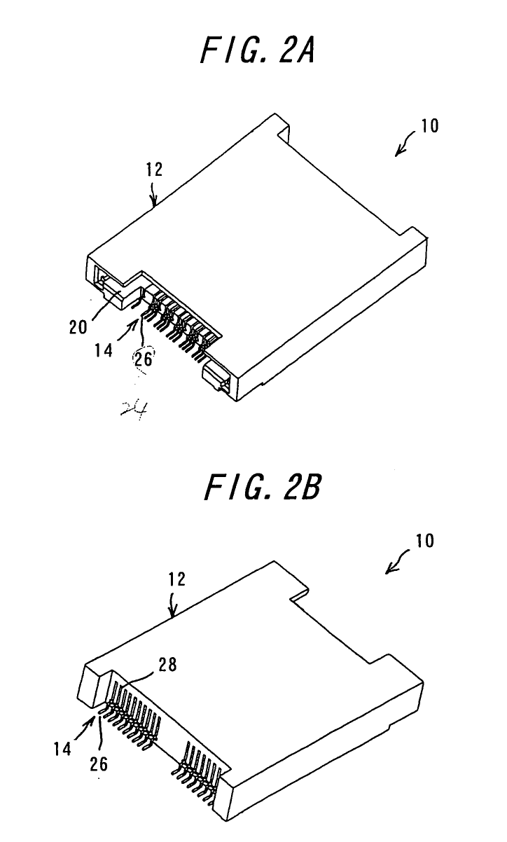

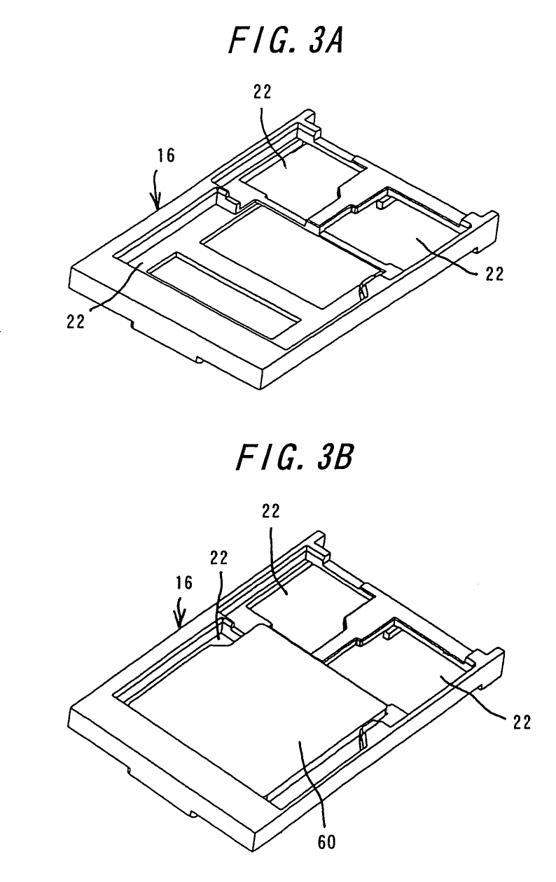

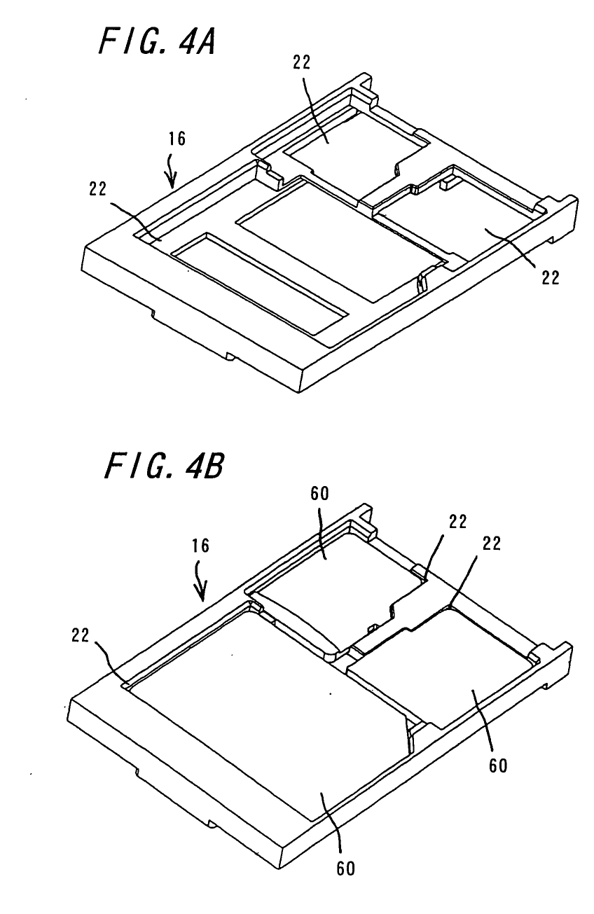

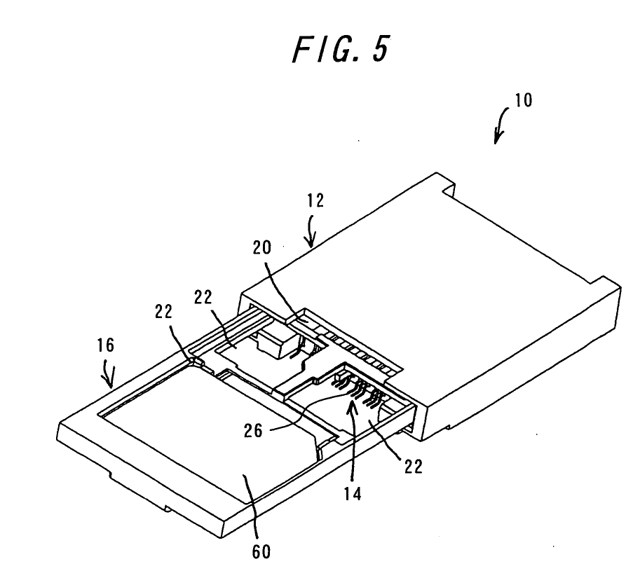

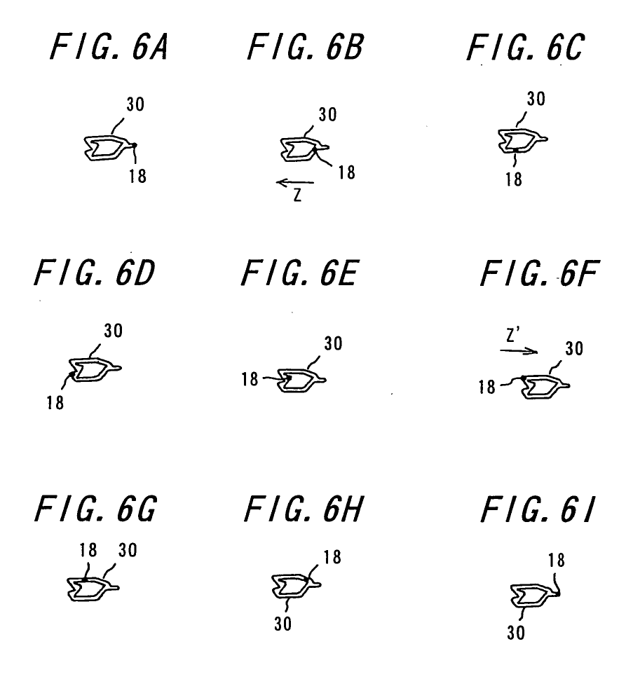

One embodiment of the invention will be explained with reference to FIGS. 1A to 6I. FIG. 1A is a perspective view of a card connector according to the invention viewed from the fitting opening side, while FIG. 1B is a perspective view of the card connector shown in FIG. 1A viewed from the opposite side of the fitting opening. FIG. 2A is a perspective view of the card connector similar to FIG. 1A with the tray removed, and FIG. 2B is a perspective view of the card connector similar to FIG. 1B with the tray removed. FIG. 3A is a perspective view of the tray used in the card connector according to the invention, while FIG. 3B is a perspective view of the tray with one card 60 mounted therein. FIG. 4A is a perspective view of the tray used in the card connector, and FIG. 4B is a perspective view of the tray with a plurality of cards mounted therein. FIG. 5 is a perspective view of the card connector with the tray drawn, viewed from the fitting opening side. FIGS. 6A to 6I are views for explaining movement of the tip of a coil spring along precut grooves when the tray is moved relative to housing of the card connector.

The card connector 10 according to the invention mainly comprises a plurality of contacts 14, a housing 12, and a tray 16.

Before explaining the components of the card connector, the cards 60 will be explained. The cards 60 are used for printers, card readers and the like. The cards 60 each mainly comprise contact portions adapted to contact the contact portions 24 of the contacts 14, patterns connecting from the contact portions of the card to circuits, and connection portions adapted to be connected to integrated circuits and central processing units mounted on the patterns. Cards 60 to be used for the card connector 10 according to the invention include Multimedia card (registered trademark), SD card (Secure Digital memory card) (registered trademark), Mini-SD card (Mini Secure Digital memory card) (registered trademark), Memory Stick card (registered trademark), SmartMedia card (registered trademark), CompactFlash card (registered trademark), xD card (registered trademark), RS-MMC card (Reduce Size MMC card) (registered trademark), Transflash card (registered trademark), S card (registered trademark), and the like, these being IC cards having built-in CPU or IC for memory.

With the tray 16 of the card connector 10 in the illustrated embodiment, the four kinds of cards can be mounted in the tray 16, that is, the Mini-SD card, RS-MMC card, Transflash card and S card. Among which, either of the Mini-SD card and RS-MMC card can be mounted in one location. In other words, three cards can be mounted in the tray 16 at a time, that is, the Transflash card and the S card, and either of the Mini-SD card and the RS-MMC.

First, the tray 16 will be explained, which is a subject matter of the invention. The tray 16 is formed from an electrically insulating plastic material by means of the injection molding of the known technique. The materials suitable for the tray 16 include polybutylene terephthalate (PBT), polyamide (66PA or 46PA), liquid crystal polymer (LCP), polycarbonate (PC) and the like and combination thereof in consideration of dimensional stability, workability, manufacturing cost and the like.

In the state that the tray has been completely inserted into the connector, the tray extends approximately 0.5 to 2 mm from the housing to facilitate drawing the tray from the housing. Engaging means using springs made of a metal or plastic material are provided on both ends in the width direction of the tray for preventing the completely inserted tray from being removed when subjected to shock and the like.

The tray 16 is provided with card mounting sections 22 for arranging a plurality of cards. The shapes of the card mounting sections 22 are adapted to correspond to the shapes of the respective cards to be mounted therein for preventing wrong cards from being mounted in the respective card mounting sections 22.

In one embodiment of the tray shown in FIGS. 3A and 3B, the card mounting sections 22 are each formed to have at least one part overlapping in relation to cards other than one card intended to be mounted in the card mounting section 22 so as to allow the intended one card only to be mounted in the card mounting section. The tray is suitably designed so that the card mounting sections only allow the intended cards to be mounted, respectively, and further in consideration of miniaturization of connector (reduced occupied areas of substrates) and holding spaces for the contacts 14 in the housing 12. In the illustrated embodiment, the tray 16 is provided with a mounting section 22 on the fitting opening side for receiving the Mini-SD card or the RS-MMC card and with mounting sections 22 on the opposite side of the fitting opening for receiving the Transflash card and the S card side by side in the width direction of the connector. The respective card mounting sections 22 are approximately 0.1 mm to 0.3 mm larger than the respective cards to be mounted in the card mounting sections.

In another embodiment of the tray 16 shown in FIGS. 4A and 4B, the tray 16 is suitably designed so that card mounting sections are each formed in a manner not having a part overlapping in relation to a plurality of cards 60 so as to allow the plurality of cards to be mounted in the card mounting section, and further in consideration of miniaturization of connector (reduced occupied areas of substrates) and holding spaces for the contacts 14 in the housing 12. Moreover, there are provided sensing means such as sensors for detecting the cards 60 to be used. The arrangement of the card mounting sections in the tray is substantially similar to that of the tray shown in FIG. 3.

The housing 12 will then be explained. The housing 12 is formed from an electrically insulating plastic material by means of the injection molding of the known technique. The materials suitable for the housing 12 include polybutylene terephthalate (PBT), polyamide (66PA or 46PA), liquid crystal polymer (LCP), polycarbonate (PC) and the like and combination thereof in consideration of dimensional stability, workability, manufacturing cost and the like. The housing 12 is provided with one fitting opening into which the tray 16 is inserted. The size of the fitting opening 20 for the tray 16 may be any size insofar as the tray 16 can be inserted into the fitting opening 20 and may be suitably designed to enable the stable connection between the cards and the contact portions 24 of the contacts 14 respectively corresponding to the cards when the insertion of the tray has been completed. The plurality of contacts are arranged and held in the housing 12 so that the contact portions 24 of the contacts 14 extend into the fitting opening 20 at positions corresponding to the respective cards corresponding to the respective contacts 14 when the insertion of the tray 16 has been completed. The housing 12 is formed with a required number of inserting holes 28 for arranging and holding the contacts 14, respectively.

The housing 12 is further provided on the side of the fitting opening 20 with stopper means for preventing the tray 16 from being unintentionally extended from the housing. For providing the stopper means, the housing 12 is formed in the proximity of the fitting opening 20 with a hole into which a member made of a metal or plastic material is fitted so as to extend slightly from the housing 12. On the other hand, the tray is provided with a protrusion at a predetermined position so that the member provided in the housing is caused to engage the protrusion of the tray, thereby forming the stopper means (not shown). The positional relationship between the member and the protrusion and their sizes may be suitably designed so that no dislodgment of the tray from the housing occurs when the tray is drawn, and cards can be mounted in the tray without any obstruction. While the member is provided in the housing as a separate part, it may be formed integrally with the housing 12. It is desirable to provide the stopper means on both the sides of the housing 12 in view of balancing of forces. However, only one stopper means may be sufficient insofar as it can perform its function.

Finally, the contacts 14 will be explained. The contacts 14 are made of a metal and formed by means of the press-working of the known technique. Preferred metals from which to form the contacts 14 include brass, beryllium copper, phosphor bronze and the like which comply with the requirements such as springiness, electric conductivity and the like. The contacts 14 each comprise at least a contact portion 24 adapted to contact the card 60, a fixed portion to be fixed to the housing 12, and a connection portion 26 adapted to be connected to a substrate.

Referring to FIGS. 6A to 61, inserting and drawing of the tray 16 will be explained. FIGS. 6A to 6I illustrate the state that the tip of a coil spring 18 moves along precut grooves 30 in the form of a heart cam. In the illustrated embodiment, the coil spring 18 and the grooves 30 in the form of the heat cam are used in consideration of fabrication cost, ease in assembling, and miniaturization of the connector. One of the side walls of the housing 12 is formed with precut grooves 30 substantially in the form of the heart cam. A tip end of the coil spring 18 is engaged in the precut grooves 30, and the other tip end of the coil spring 18 is held in the housing 12 at a predetermined position such that the central portion of the coil spring 18 is in contact with the tray 16. Before inserting the tray 16 into the housing (or after removal of the tray), the tip end of the coil spring 18 is at a position X (FIGS. 6A and 61), while when the tray 16 has been completely inserted, the tip end of the coil spring 18 is at a position Y (FIG. 6E). When it is desired to remove the tray 16, the tray 16 is somewhat pushed by hand, as a result of which, the tip end of the coil spring 18 passes along the grooves on the side shown by an arrow Z and moves into the position X, whereby the tray 16 is removed from the housing by the elastic force of the coil spring 18. When it is desired to insert the tray 18 into the housing 12, the coil spring 18 is pushed by the tray 16 so that the tip end of the coil spring 18 passes along the grooves on the side shown by an arrow Z′ and moves into the position Y, whereby the insertion of the tray 16 has been completed.

The present invention is applicable to card connectors for use in electric and electronic appliances in instruments and for use in printers and card readers, and particularly to connectors of miniaturization in height or reduced overall height which is achieved by the use of the tray 16 according to the invention.

While the invention has been particularly shown and described with reference to the preferred embodiments thereof, it will be understood by those skilled in the art that the foregoing and other changes in form and details can be made therein without departing from the spirit and scope of the invention.

1. A card connector which is able to be connected to at least two cards,
said card connector comprising contacts corresponding to the number of the cards, a tray in which at least two cards can be mounted, and a housing having a fitting opening for receiving said tray therein and for arranging and holding said contacts.

2. A card connector which is able to be connected to four cards,
said card connector comprising four kinds of contacts, a tray having card mounting sections in which four cards can be mounted, and a housing having a fitting opening for receiving said tray therein and for arranging and holding said four kinds of contacts.

3. The card connector as set forth in claim 1, wherein said tray is provided with at least one card mounting section having at least one part overlapping in relation to cards other than one card intended to be mounted in the card mounting section so as to allow the intended one card only to be mounted in the card mounting section.

4. The card connector as set forth in claim 1, wherein said tray is provided with at least one card mounting section not having a part overlapping in relation to at least two cards so as to allow at least the two cards to be mounted in the card mounting section, and said tray is further provided with card identification means for identifying the cards to be used.

5. The card connector as set forth in claim 1, wherein said housing is provided with stopper means on the side of said fitting opening for preventing said tray from being extended from said housing.

6. The card connector as set forth in claim 1, further comprising means for drawing said tray to some extent relative to said housing by pushing said tray in the state that insertion of said tray has been completed.

7. The card connector as set forth in claim 2, wherein said tray is provided with at least one card mounting section having at least one part overlapping in relation to cards other than one card intended to be mounted in the card mounting section so as to allow the intended one card only to be mounted in the card mounting section.

8. The card connector as set forth in claim 2, wherein said tray is provided with at least one card mounting section not having a part overlapping in relation to at least two cards so as to allow at least the two cards to be mounted in the card mounting section, and said tray is further provided with card identification means for identifying the cards to be used.

9. The card connector as set forth in claim 2, wherein said housing is provided with stopper means on the side of said fitting opening for preventing said tray from being extended from said housing.

10. The card connector as set forth in claim 3, wherein said housing is provided with stopper means on the side of said fitting opening for preventing said tray from being extended from said housing.

11. The card connector as set forth in claim 4, wherein said housing is provided with stopper means on the side of said fitting opening for preventing said tray from being extended from said housing.

12. The card connector as set forth in claim 2, further comprising means for drawing said tray to some extent relative to said housing by pushing said tray in the state that insertion of said tray has been completed.

13. The card connector as set forth in claim 3, further comprising means for drawing said tray to some extent relative to said housing by pushing said tray in the state that insertion of said tray has been completed.

14. The card connector as set forth in claim 4, further comprising means for drawing said tray to some extent relative to said housing by pushing said tray in the state that insertion of said tray has been completed.

15. The card connector as set forth in claim 5, further comprising means for drawing said tray to some extent relative to said housing by pushing said tray in the state that insertion of said tray has been completed.
